(19) United States
(12) Patent Application Publication
(10) Pub. No.: US 2025/0253071 A1
(43) Pub. Date: Aug. 7, 2025

(54) REELABLE SUPPORT MEMBER

(71) Applicant: Paradigm Technology Services B.V., Groot-Ammers (NL)

(72) Inventor: Jan Arie Aldo Huizer, Groot-Ammers (NL)

(21) Appl. No.: 18/854,689

(22) PCT Filed: Apr. 6, 2023
(86) PCT No.: PCT/EP2023/059256

§ 371 Date: Oct. 7, 2024

(30) Foreign Application Priority Data
Apr. 8, 2022 (GB) 2205178.3

(51) Int. Cl. H01B 11/18; E21B 17/00; H01B 1/04; H01B 7/285; H01B 13/02; H01B 13/32; H02G 11/02

(52) U.S. Cl. CPC H01B 11/1821; E21B 17/003; H01B 1/04; H01B 7/285; H01B 13/0292; H01B 13/322; H02G 11/02

(57) ABSTRACT

A reelable support member for downhole operations comprising a plurality of composite strands and a filler matrix between the plurality of composite strands, wherein each composite strand comprises carbon fibres and epoxy; and a method of manufacturing the reelable support member by winding a plurality of composite strands around a core, each composite strand comprising carbon fibres and epoxy, and applying a filler matrix between the plurality of composite strands.

### FIELD

The present disclosure relates to a reelable support member for use in downhole operations, and to a method of making such a reelable support member.

### BACKGROUND

In the oil and gas exploration and production industry, wide use is made of reelable support member, such as slickline, wireline and electric line, to run devices and tools into oil wells. Slickline tends to be relatively small diameter solid wire, while wireline typically comprises braided wires. Reelable support members may include power and/or signal carrying elements such as electrical conductors and/or optical fibres.

There have been numerous proposals for slickline and wireline including non-metallic elements. However, the great majority of slickline and wireline is primarily metallic, and in particular steel. Steel reelable support members have limitations in their use for well diagnostics, intervention, workover and completion operations.

### SUMMARY

In a first aspect there is provided a reelable support member for downhole operations, the member comprising a plurality of composite strands and a filler matrix between the plurality of composite strands, wherein each composite strand comprises carbon fibre and epoxy.

The reelable support member may be a multipurpose composite cable that is capable of replacing both slickline and electric line in wireline operations which use existing wireline equipment including winches, drums, sheaves, pressure control equipment, etc. The reelable support member may be suitable for well diagnostics, production, intervention, workover and completion operations. Well diagnostics operations may include production logging, flow monitoring, fibre optic distributed temperature sensing, fibre optic distributed acoustic sensing, etc. Intervention operations may include running and setting downhole assemblies such as subsurface safety valves, side pocket mandrels, packers, crown plugs, etc.; running non-setting tool strings such as drifts, gauge cutters, bailers, etc.; fishing; pipe recovery; etc. The reelable support member may be used for conveyance, communication, and/or electrical power supply. The reelable support member may be used in combined wireline-slickline deployments. The reelable support may be particularly suitable for high pressure (e.g. well pressure up to 1034 bar (15000 psi)) and high temperature (e.g. continuous well temperature up to 177° C. (350° F.)) wellbore applications. The reelable support member may have high chemical resistance. In particular, the reelable support member may be resistant to well fluids and gas, for example crude oil, brine, produced water, multi phase, CO₂, MEG/H₂O mix, MeOH, organic stimulation acid, Kformate, HCl, natural gas, etc. The reelable support may be particularly suitable for environmentally sensitive operations. The reelable support member may be suitable for use in both sweet and sour downhole environments. The reelable support member may be particularly suitable for downhole operations in long, extended-reach, highly deviated, tortuous, and/or horizontal wellbores. The reelable support member may be particularly suitable for use at limited-footprint well sites.

Beneficially, the composite strands may provide both high strength and high flexibility, this making the reelable support member suitable for dynamic use. The reelable support member may have a specific strength four times greater than that of a steel cable The filler matrix may permit inter-strand movement with low friction therebetween to improve longevity of the reelable support member. The reelable support member may be lightweight, thus capable of supporting a higher pay load and longer and heavier tool strings than conventional reelable support members.

Furthermore, the lightweight, almost neutrally buoyant, nature of the reelable support member may allow the reelable support member to access hard to reach wells. The reelable support member may be torque free, thus no seasoning or re-torquing of the reelable support member is required which reduces the maintenance requirements of the reelable support member. The reelable support member may provide minimised surface tensions, thus enabling higher downhole pull capacity. Further, the reelable support member may provide less tubing wear in a coated or lined production tubing. Further benefits of the reelable support member include higher operational efficiency and reduced health and safety risks.

Each composite strand may have a specific gravity between 1.5 kg/dm³ and 1.7 kg/dm³. The specific gravity of each composite strand may depend on the carbon fibre volume of the composite strand. Each composite strand may have a specific gravity of 1.6 kg/dm³.

Each composite strand may have a tensile strength between 1000 MPa and 3000 MPa. Preferably, each composite strand may have a tensile strength between 1400 MPa and 2600 MPa. Each composite strand may have a tensile elastic modulus up to 140 GPa. Preferably, each composite strand may have a tensile elastic modulus up to 132 GPa. Preferably, each composite strand may have a tensile elastic modulus up to 126 GPa. The elongation at breaking point of each composite strand may be less than or equal to 2%, preferably 1.7%. Each composite strand may have low creep strain. Each composite strand may have a creep elongation of 0.0068% after 1000 hrs at 22° C. Each composite strand may have a strain load of 65% of the minimum breaking load.

The epoxy of the composite strands may be in the form of a thermoset resin. The epoxy may be pre-impregnated into the carbon fibres. The epoxy of the composite strands may comprise or be formed of high glass transition temperature (Tg) epoxy resin, e.g. the glass transition temperature of the epoxy may be 200° C. The epoxy of the composite strands may be toughened. The epoxy may form part of a resin blend. The resin blend may be a thermoset resin. The resin blend may further comprise at least one of polydicyclopentadiene (PDCPD), toughened bismaleimide, cyanate ester and polyimide.

The filler matrix may comprise or be formed of a polymer, e.g. an elastomer. The filler matrix may be flexible and/or elastic. The filler matrix may have a high elongation capability. The filler matrix may comprise or be formed of a thermoset polymer. The filler matrix may comprise or be formed of a thermoplastic polymer. The reelable support member may be gas-blocked. The filler matrix may be impermeable. The filler matrix may prevent the migration of fluid, e.g. gas and/or liquid, through and/or along the reelable support member. The filler matrix may be pressure tight to at least 104 MPa. Further, the filler matrix may be resistant to high temperatures. The filler matrix may be resistant to temperatures in the range of −40° C. to 200° C. The filler matrix may provide lubrication between the plurality of composite strands. The filler matrix may reduce abrasion of the plurality of composite strands when the reelable support member is in dynamic use, for example as a winch cable, and reverse bending under tension. The filler matrix may be chemical resistant. The filler matrix may be ageing resistant.

The filler matrix may be a gel. Alternatively, the filler matrix may comprise tape and/or monofilament. The tape may seal the core and/or each composite strand.

The filler matrix may comprise or be formed of liquid silicon rubber, fluoro liquid silicone rubber, fluoro polymer, ethylene tetrafluoroethylene (ETFE), thixotropy gel, polyether ether ketone (PEEK), fluoro polymer modified PEEK (mPEEK), ethylene chlorotrifluoroethylene (ECTFE), Polytetrafluoroethylene (PTFE), etc. Where the filler matrix comprises or is formed of PTFE, the quality of the PTFE may be low density expanded PTFE or full density PTFE. Where the filler matrix comprises or is formed of PTFE, the PTFE may have a density between 0.4 g/cm³ and 1.6 g/cm³. Where the filler matrix comprises or is formed of PTFE, the PTFE may have a tensile strength >6 MPa. The PTFE may have an elongation >40%.

The reelable support member may comprise interstitial spaces between the plurality of composite strands. The filler matrix may fill the interstitial spaces between the plurality of strands. The interstitial spaces may form less than 5% of the volume of the reelable support member, thus the filler matrix may form less than 5% of the volume of the reelable support member. The monofilament may substantially fill the interstitial spaces, e.g. the monofilament may fill the majority of the volume of the interstitial spaces.

The carbon fibre of at least one composite strand of the plurality of composite strands may be configured to transmit electrical signals for communication along the reelable support member. Beneficially, providing communication along at least one of the composite strands negates the need for a traditional conductor within the reelable support member thus the area of the strength members, e.g. the composite strands, of the reelable support member is maximised.

The reelable support member may be configured to support a tool at a downhole end of the reelable support member.

The reelable support member may comprise a core.

The core may be a composite strand of the plurality of composite strands. The carbon fibre of the composite strand forming the core may be the carbon fibre configured to transmit electrical signals for communication, preferably real-time 2-way communication, along the reelable support member.

Each composite strand may have a specific resistance of 3000 μΩcm.

Alternatively, the core may be a functional core. The functional core may be configured to supply electrical power to a tool supported by the reelable support member. The functional core may be configured to transmit real-time 2-way communication along the reelable support member. The functional core may be a polymer tube, metal core, a fibre optic in a metal tube (FIMT), a coaxial cable (coax), a hybrid coax-FIMT, a capillary metal tube, a multi conductor, a hybrid multi conductor-FIMT, twisted pair, etc.

Carbon fibre of each composite strand may be in the form of a carbon fibre tow. The carbon fibre tow may be roving. The roving may be unidirectional roving. The roving may be 12 k roving. Each composite strand may comprise a plurality of carbon fibre tows. Each composite strand may have a diameter between 1 mm and 5 mm. Each composite strand may have a diameter of 1.2 mm, 1.6 mm, 1.8 mm, 2.6 mm, 3.3 mm, 3.6 mm or 4.2 mm. The number of tows comprised in each composite strand may directly correspond to the diameter of the composite strand Each composite strand may comprise between 1 and 20 carbon fibre tows. Each composite strand may comprise 1, 2, 3, 6, 10, 12 or 15 carbon fibre tows. The carbon fibre tows of each composite strand may be twisted, preferably right-hand twisted, at an angle between 5° and 15°, preferably between 6° and 10°. The carbon fibre tows of each composite strand may form between 55% and 70% of the volume of said composite strand. The carbon fibre tows may have a strength between 4500 MPa and 4900 MPa. The standard tensile modulus of each carbon fibre tow may be up to 240 GPa. Preferably, the standard modulus of each carbon fibre two may be 230 GPa. The breaking strain of each carbon fibre tow may be less than 2%.

Each composite strand may further comprise reinforcement fibre. The reinforcement fibre may include at least one of aramid, glass, basalt and carbon multi filament.

A protection layer may be wrapped around each composite strand. Beneficially, the protection layers may prevent bonding between the composite strands after the plurality of composite strands are wrapped around a core. The protection layers may allow for axial movement between the composite strands in use. The protection layers may be resistant to abrasion, high temperatures, chemicals, hydrolysis, etc. Beneficially, the protection layers may protect the composite strand against mechanical damage such as abrasion when bending the reelable support member, e.g. during processing or manufacturing, or when using the reelable support member as a winch cable. The protection layers may improve the strength of the reelable support member. The protection layers may distribute tangential and/or point shear loads between composite strands that come into contact when the reelable support member is under bending and/or tension loading. The protection layers may improve the hoop strength of the strands to enhance the crush resistance of the strands and thus the reelable support member.

Each protection layer may comprise at least one of a multifilament fibre wrap, a yarn wrap, a dry fibre wrap, a unidirectional fibre reinforced tape wrap, a thermoplastic tape wrap, a polymeric yarn, etc. Each protection layer may comprise one or more layers. Where each protection layer comprises a plurality of layers, the layers may comprise the same or different types of wrap. Where each protection layer comprises a plurality of layers, adjacent layers may be wrapped in opposite directions. Each protection layer may comprise or be formed of Technora® (preferably Technora® yarn size 1670 dtex, untwisted), Kevlar®, Vectran™, aramid, para-aramid, liquid-crystal polymer (LCD), glass fibre, basalt yarn, etc. Beneficially, a protection layer comprising Technora® and/or aramid may provide uniform coverage to the composite strand. Each protection layer may have a thickness, e.g. a single layer thickness, between 0.1 mm and 0.25 mm, preferably 0.15 mm. Each protection layer may be wrapped around the composite strand at a wrap angle between 30° and 80°, preferably 50°. The yarn wrap may have a width between 1 mm and 3 mm. The width of the yarn wrap may depend on yarn spreading before wrapping. The unidirectional fibre reinforced tape wrap may comprise thermoplastic, for example ETFE, PEEK, ECTFE, mPEEK, PFA, PPS, PTFE, etc. The carbon fibre and epoxy may be moveable within the unidirectional fibre reinforced tape wrap. The unidirectional fibre reinforced tape wrap of adjacent composite strands may be melt fused together. The polymeric yarn may comprise or be formed of thermoset resin, in particular thermoset resin that is tough and/or ductile.

Each composite strand of the plurality of composite strands may have a circular cross-sectional shape. Alternatively, each composite strand of the plurality of composite strands may have a non-circular cross-sectional shape.

The density of the reelable support member may be at least 1.6 kg/dm³. Beneficially the reelable support member may have a high strength-to-weight ratio.

The reelable support member may have a diameter between 3 mm and 30 mm, for example 5.3 mm, 7.8 mm, 9.9 mm or 10.8 mm. Preferably the reelable support member may have a diameter between 4 mm and 15 mm, further preferably between 6 mm and 14 mm. The reelable support member may have a constant diameter along its length. The reelable support member may have a length up to 15000 m. Preferably, the reelable support member may have a length of 12200 m.

The minimum cable bending diameter of the reelable support member may be between 400 mm and 1200 mm, with a D/d ratio less than 80 at 40% of the minimum break load of the reelable support member. Beneficially, the construction of the reelable support member allows for a small D/d ratio in combination with a high allowable working load.

The reelable support member may be configured to have a safe working load up to 8000 kg. The reelable support member may be configured to have a maximum working load between 40% and 60% of its minimum break load. Beneficially, the specific strength of the reelable support member may be up to four times higher than that of a steel wireline. The reelable support member may have a high tensile strength, with minimal elongation, and high reverse bending fatigue life. The fatigue life of the reelable support member may be particularly improved as compared to steel wireline cables due to the materials of the reelable support member. Where the reelable support member is of a torque balanced construction, there may be minimal cable rotation when the reelable support member is under tensile load due to the reelable support member being torque free.

The bending modulus of the reelable support member may be much smaller that the tensile modulus due to the relatively small bending diameter.

The reelable support member may comprise a jacket. The jacket may be an outer layer of the reelable support member. The plurality of composite strands may be arranged, e.g. wound, between the core and the jacket. The jacket may comprise or be formed of polymer. The jacket may comprise a smooth outer surface. The jacket may comprise or be formed of PEEK, mPEEK, fluorpolymer modified PEEK, ETFE polymer, ECTFE, PTFE etc. The material of the jacket may improve impact and wear resistance of the reelable support member, thus the jacket may be abrasion resistant. The material of the jacket may reduce the friction coefficient of the outer surface of the reelable support member, thus the jacket may be a low friction jacket. Lower friction improves well access thereby allowing access to hard to reach wells, allows for increased overpull margins and allows for faster running speed. The jacket may have a tensile strength up to 100 MPa. The jacket may be flexible. The jacket may have elongation between 50% and 400%. A melt point of the jacket may be greater than 250° C. The jacket may be resistant to continuous temperatures up to 200° C. The jacket may be resistant to chemical ageing. The jacket may have a compression strength suitable for the reelable support member to be spooled on a multilayer drum at tension.

The material of the filler matrix and the material of the jacket may be compatible, in order to promote adhesion between the filler and the jacket. The material of the filler matrix and the material of the jacket may be the same. The material of the filler matrix and the material of the jacket may be ECTFE, mPEEK, ETFE polymer or PTFE. The ETFE polymer may be irradiation electro-beam crosslinked.

The reelable support member may comprise a support layer. The support layer may be between the composite strands and the jacket. Alternatively, the support layer may be embedded in jacket, e.g. the support layer may be an intermediary layer between an inner jacket and an outer jacket. Beneficially the support layer may improve the hoop strength of the reelable support member to improve crush resistance, protect the composite strands against impact loads, and distribute point loads on the reelable support member. The support member may comprise Technora®, Kevlar®, Vectran™, glass, basalt, etc.

The support layer may comprise or be formed of thermoplastic unidirectional fibre reinforced tape. The thermoplastic unidirectional fibre reinforced tape may comprise ETFE, PEEK, mPEEK, PFA, PPS, PTFE, etc. The thermoplastic unidirectional fibre reinforced tape may comprise the same thermoplastic as the jacket. The unidirectional fibre reinforcing the tape may comprise or be formed of Technora®, Kevlar®, Vectran™, aramid, glass, basalt, etc. Preferably the thermoplastic unidirectional fibre reinforced tape may comprise ETFE and aramid fibre or glass fibre. The thermoplastic unidirectional fibre reinforced tape may have a width between 3 mm and 12 mm. The thermoplastic unidirectional fibre reinforced tape may have a thickness, e.g. single layer thickness, between 0.1 mm and 0.25 mm. The thermoplastic unidirectional fibre reinforced tape may be wrapped around the plurality of composite strands at an angle between 30° and 70°. The thermoplastic unidirectional fibre reinforced tape may be wrapped in an s-lay or a z-lay. The support layer may comprise a plurality of layers of thermoplastic unidirectional fibre reinforced tape. Adjacent layers may be wrapped in opposite directions.

The support layer may comprise or be formed of a braid. The braid angle may be between 20° and 70°, preferably 50°. The braid may comprise synthetic braid material and/or metallic braid material. The synthetic braid material may be Technora®, Kevlar®, Vectran™, glass, basalt, etc. The metallic braid material may be high strength steel wire, stainless steel wire, copper alloy wire, etc. The metallic braid material may have a diameter of 0.2 mm. The metallic braid material may be configured to conduct electrical signals along the reelable support member. The braid may have a 3 over 3 braid pattern. The braid may have a thickness between 0.2 mm and 0.5 mm.

In a second aspect there is provided a method of producing a reelable support member for downhole operations, the method comprising:
winding a plurality of composite strands around a core, each composite strand comprising carbon fibre and epoxy; and
applying a filler matrix between the plurality of composite strands.

The plurality of composite strands may be semi-cured before winding the plurality of composite strands around a core. In particular, the composite strands may be prepreg semi cured strands. The method may further comprise forming each composite strand by twisting together a plurality of prepreg carbon fibre tows.

The method may further comprise wrapping each composite strand with a protection layer before winding the plurality of composite strands around the core. Beneficially, the protection layer may prevent bonding between the composite strands after the plurality of composite strands are wrapped around the core. This may allow for axial movement between the composite strands in use. The protection layer may comprise a multifilament wrap, a yarn wrap, a dry fibre wrap, a thermoplastic unidirectional fibre reinforced tape wrap, a polymeric yarn, etc.

The protection layer may be wrapped at an angle between 30° and 80°, preferably 50°.

Each composite strand may be wrapped with the protection layer before semi-curing the composite strand. Alternatively, each composite strand may be wrapped with the protection layer after semi-curing the composite strand.

After winding each composite strand around a core, the method may further comprise forming and compacting the plurality of composite strands. The plurality of composite strands may be formed and compacted using a die or a roller. The plurality of composite strands may be pulled through the die or roller. Pulling the plurality of composite strands through a die may also push the outer strands into the filler matrix. Beneficially, forming and compacting the plurality of composite strands may reduce the size of the interstitial spaces between the plurality of composite strands.

The method may further comprise curing the plurality of composite strands after winding the plurality of composite strands around the core. Fully curing the plurality of composite strands may be performed after shaping the plurality of composite strands. The method may further comprise curing the protection layer and bonding the protection layer to the composite strand. Curing the protection layer and bonding the protection layer to the composite strand may be done in the same process are curing the plurality of composite strands.

The filler matrix may be applied between the plurality of composite strands during winding the plurality of composite strands around the core. Applying the filler matrix between the plurality of composite strands may comprise running the plurality of composite strands through a bath of filler matrix. The method may further comprise wiping excess filler from the plurality of composite strands after running the plurality of composite strands through the bath.

Alternatively, the filler matrix may be applied to the plurality of composite strands after winding the plurality of composite strands around the core. The method may further comprise opening, e.g. temporarily opening, the plurality of composite strands after winding the plurality of composite strands around the core. The plurality of composite strands may be opened after the plurality of composite strands are fully cured. Opening the plurality of composite strands may comprise reconfiguring the plurality of composite strands from a wound configuration to an open configuration. The wound configuration may be achieved via the step of winding the plurality of composite strands around the core. In the open configuration the plurality of composite strands may be spaced apart. The plurality of composite strands may be opened using a rotating caterpillar or the like. Applying the filler matrix between the plurality of composite strands may comprise injecting the filler matrix between the opened plurality of composite strands. After the filler matrix has been applied to the plurality of composite strands, the plurality of composite strands may be returned, e.g. released, to the wound configuration.

Winding the plurality of composite strands around the core may comprise helically winding the plurality of composite strands around the core. The plurality of composite strands may be wound around the core in an s-lay or a z-lay. The plurality of composite strands may be wound around the core at a lay angle between 5° and 30°, preferably between 5° and 25°, further preferably between 8° and 10°. Winding the plurality of composite strands around the core may comprise winding, e.g. helically winding, subsets of the plurality of composite strands in layers. Winding the plurality of composite strands around the core may comprise winding, e.g. helically winding, adjacent layers in opposite directions. The method may further comprise torque balancing the wound layers of composite strands.

Opening the plurality of composite strands and injecting the filler matrix between the opened plurality of composite strands may comprise opening a layer of composite strands and injecting filler matrix between the opened layer of composite strands before winding a subsequent layer of composite strands.

The filler matrix may comprise or be formed of a flexible polymer. The filler matrix may comprise or be formed of liquid silicon rubber, fluoro liquid silicone rubber, fluor polymer, ETFE, thixotropy gel, mPEEK, ECTFE, PTFE etc.

The filler matrix may be a thermoset polymer. The method may further comprise curing the filler matrix. Fully curing the plurality of composite strands and curing the filler matrix may be done in a single curing operation.

Alternatively, the filler matrix may be a thermoplastic polymer.

The filler matrix may be applied before winding the plurality of composite strands around the core. The filler matrix may be applied to the core and/or to the plurality of composite strands before winding the plurality of composite strands around the core.

Applying the filler matrix between the plurality of composite strands may comprise jacketing the core with the filler matrix. The core may be jacketed with the filler matrix before winding the plurality of composite strands around the core. Applying the filler matrix between the plurality of composite strands may further comprise heating the filler matrix of the jacketed core during winding the plurality of composite strands around the jacketed core such that the plurality of composite strands become embedded in the filler matrix of the jacketed core.

Applying the filler matrix between the plurality of composite strands may comprise wrapping the core and/or the composite strands with the filler matrix. The core and/or the composite strands may be wrapped with the filler matrix before winding the plurality of composite strands around the core. The core may be wrapped with the filler matrix before the plurality of composite strands are cured. The filler matrix may be in the form of tape and/or monofilament. The core may be wrapped with filler matrix material tape. The tape may seal the core. Filler matrix material in the form of monofilament may be provided around the core by wrapping or otherwise. Filler matrix material in the form of monofilament may be provided directly around the core or on top of a filler matrix material wrap around the core. The monofilament may fill a substantial volume of the interstitial spaces, e.g. the majority of the volume of the interstitial spaces. The tape and/or monofilament may be formed of or comprise PTFE. The tape may have a width between 2 mm to 10 mm. The tape may have a thickness between 0.1 mm to 0.2 mm. The tape may have a single splice free length of up to 20000 m long. Wrapping the core and/or the composite strands with the tape may comprise applying a single wrap. The single wrap may have a 50% overlap. Alternatively, wrapping the core and/or the composite strands with tape may comprise applying a dual cross wrap. The dual cross wrap may have between 0 and 50% overlap. The core and/or composite strands may be wrapped in tape using a cable taping machine. Applying the filler matrix between the plurality of composite strands may further comprise pulling the core and/or composite strands wrapped in filler matrix through a die. Beneficially, this may calibrate the outer diameter of the wrapped core and/or composite strands. Further, this may calibrate the thickness of the filler matrix. The die may be sized so that the filler matrix is given a thickness large enough to fill interstitial spaces between the plurality of composite strands. Applying the filler matrix between the plurality of composite strands may comprise embedding the plurality of composite strands in the filler matrix during winding of the plurality of composite strands around the core. Applying the filler matrix between the plurality of composite strands may comprise pulling the plurality of composite strands through a die after wrapping the plurality of composite strands around the core. Beneficially, this may calibrate the outer diameter of the reelable support member and/or push the plurality of composite strands into the filler matrix.

Applying the filler matrix between the plurality of composite strands may comprise applying filler matrix material in the form of a thermoplastic layer to each composite strand before winding the plurality of composite strands around the core. The thermoplastic layer may be applied to each composite strand after wrapping each composite strand with the protection layer. Alternatively, the thermoplastic layer may also be the thermoplastic unidirectional reinforced fibre tape wrap protection layer. Applying the filler matrix between the plurality of composite strands may comprise heating the thermoplastic layer of each composite strand after winding the plurality of composite strands around the core to melt and fuse the thermoplastic layers. The thermoplastic layer may comprise or be formed of ETFE, ECTFE, PEEK, modified PEEK, PFA, PPS, LCP, PTFE, etc. The thermoplastic layer may have a thickness between 0.1 mm and 0.25 mm, preferably 0.15 mm. The thermoplastic layer may be in the form of a jacket, a tape wrap, a multifilament fibre or yarn wrap, a thermoplastic unidirectional fibre reinforced tape wrap, etc. The multifilament yarn may have a width between 1 mm and 3 mm. The width of the multifilament yarn may depend on yarn spreading before wrapping. The multifilament yarn may be ETFE yarn size 1670 dtex, untwisted. The unidirectional fibre reinforced tape wrap may be reinforced with Technora®, Kevlar®, Vectran™, glass or basalt fibres. Preferably the unidirectional fibre reinforced tape wrap may be formed of ETFE reinforced with aramid or glass fibre. The unidirectional fibre reinforced tape wrap may have a width between 3 mm and 12 mm. The thermoplastic layer may be formed of multiple layers of unidirectional fibre reinforced tape wrap. Adjacent layers of unidirectional fibre reinforced tape wrap may be wrapped in alternating s-lay and z-lay directions. The multifilament fibre or yarn, or the unidirectional fibre reinforced tape, may be wrapped around the composite strand at an angle between 30° and 70°, preferably 50°.

The method may further comprise jacketing the filled plurality of composite strands with a jacket. The jacket may be formed around, e.g. on top of, reinforcement braid or unidirectional fibre reinforced tape wrapped around the filled plurality of composite strands. The jacket may form an outer layer of the reelable support member. The jacket may be a polymer jacket. The polymer jacket may comprise or be formed of a polymer compatible with the polymer of the filler matrix. The polymer jacket may comprise or be formed of the same material as the filler matrix. The polymer jacket and the filler matrix may comprise or be formed of ETFE, ECTFE mPEEK or PTFE. The jacket may be abrasion resistant. The jacket may have a smooth outer surface. The jacket may be a low friction jacket. The method may further comprise electro-beam crosslinking the jacket.

The method may further comprise applying a support layer around the filled plurality of composite strands. The support layer may be applied before jacketing the filled plurality of composite strands. Alternatively, the support layer may be applied during jacketing the filled plurality of composite strands so that the support layer is embedded in the jacket, e.g. the support layer is between an inner jacket and an outer jacket. The support layer may comprise a reinforcement braid. The reinforcement braid may be braided around the filled plurality of composite strands by a braider. The braided may comprise between 18 and 48 spools. The reinforcement braid may be braided around the filled plurality of composite strands in a 3 over 3 braid pattern. The support layer may comprise one or more layers of thermoplastic unidirectional fibre reinforced tape wrapped around the filled plurality of composite strands. The method may further comprise melting and fusing layers of thermoplastic unidirectional fibre reinforced tape.

One or more of the steps in the method may be carried out in a separate process and/or on a separate manufacturing line from one or more of the other steps in the method.

The above summary is intended to be merely exemplary and non-limiting. It should be understood that features defined above in accordance with any aspect of the present disclosure or below relating to any specific embodiment of the disclosure may be utilized, either alone or in combination with any other defined feature, in any other aspect or embodiment or to form a further aspect or embodiment of the disclosure.

### BRIEF DESCRIPTION OF THE DRAWINGS

FIG. 1 is a transverse cross-section of a first reelable support member;

FIG. 2 is a transverse cross-section of a composite strand of the reelable support member of FIG. 1.

FIG. 3 is a transverse cross-section of a second reelable support member;

FIG. 4 is a transverse cross-section of a third reelable support member;

FIG. 5a is a side view of a composite strand of the reelable support member of FIG. 4;

FIG. 5b is a transverse cross-section of the composite strand of FIG. 5a;

FIG. 6 is a transverse cross-section of a fourth reelable support member;

FIG. 7 is a transverse cross-section of a fifth reelable support member;

FIG. 8 is a transverse cross-section of a sixth reelable support member;

FIG. 9a is a transverse cross-section of a seventh reelable support member;

FIG. 9b is a detailed side view of braiding of the reelable support member of FIG. 9a;

FIG. 10 is a transverse cross-section of an eighth reelable support member;

FIG. 11a is an elevation view of a composite strand of the reelable support member of FIG. 10;

FIG. 11b is a transverse cross-section of the composite strand of FIG. 11a;

FIG. 12 is a schematic of a first process for manufacturing a reelable support member;

FIG. 13 is a schematic of a second process for manufacturing a reelable support member;

FIGS. 14a to 14d are schematics of a third process for manufacturing a reelable support member; and

FIG. 15 is a schematic of a fourth process for manufacturing a reelable support member;

FIG. 16a is a transverse cross-section of a wrapped core of a modified version of the manufacturing process of FIG. 15;

FIG. 16b is an elevation view of a first method of wrapping the core of FIG. 16a;

FIG. 16c is an elevation view of a second method of wrapping the core of FIG. 16a;

FIG. 16d is a transverse cross-section of a reelable support member of the modified version of the manufacturing process of FIG. 15;

FIG. 17a is an elevation view of an alternative composite strand for use in manufacturing a reelable support member;

FIG. 17b is a transverse cross-section of the composite strand of FIG. 17a;

FIG. 18a is an elevation view of an alternative composite strand for use in manufacturing a reelable support member;

FIG. 18b is a transverse cross-section of the composite strand of FIG. 18a;

FIG. 19a is an elevation view of an alternative composite strand for use in manufacturing a reelable support member;

FIG. 19b is a transverse cross-section of the composite strand of FIG. 19a;

FIGS. 20a and 20b are transverse cross-sections of a reelable support member before and after a compacting process.

### DETAILED DESCRIPTION OF THE DRAWINGS

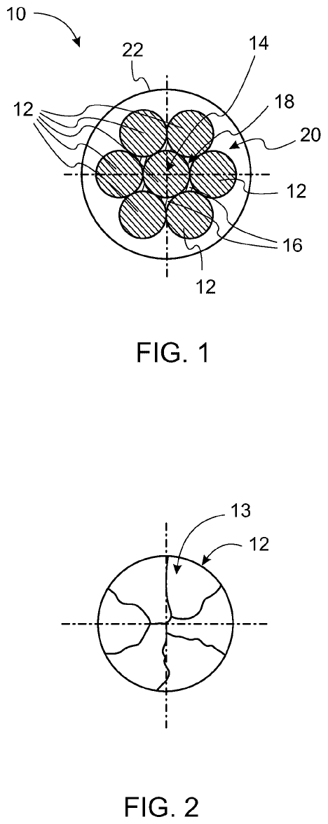

FIG. 1 shows a reelable support member 10. The reelable member 10 comprises a plurality of composite strands 12. In particular, the reelable support member 10 comprises seven composite strands. Other reelable support members may comprise more or less than seven composite strands. The number of composite strands may depend on the diameter of the composite strands. Each composite strand has a tensile strength of approximately 2500 MPa.

As shown in FIG. 2, each composite strand 12 comprises a plurality of carbon fibre tows 13. Each carbon fibre tow 13 is unidirectional 12 k roving. Each carbon fibre tow 13 has a strength of at least 4500 MPa, a standard tensile modulus of up to 240 GPa, and breaking strain less than 2%. Each carbon fibre tow 13 is right-hand twisted at an angle of 8°. In other reelable support members the each carbon fibre tow may be twisted at an angle between 5° and 15°. Each composite strand 12 comprises six carbon fibre tows 13. Each composite strand 12 has a diameter of 2.6 mm. In other reelable support members each composite strand may comprise more or less than six carbon fibre tows. In other reelable support members each composite strand may have a diameter more or less than 2.6 mm. The diameter of each composite strand may be proportional to the number of carbon fibre tows comprised in the composite strand. Carbon fibre makes up 60% of the volume of each composite strand 12. In other reelable support member, the carbon fibre makes up between 55% and 70% of the volume of each composite strand. Each composite strand 12 further comprises epoxy in the form of a thermoset resin (not shown) impregnated in the carbon fibre tows.

Referring again to FIG. 1, the composite strand 12 of the plurality of composite strands forms a core 14 of the reelable support member 10. The core composite strand 14 is configured to transmit electrical signals for real-time 2-way communication along the reelable support member 10. The core composite strand 14 is in the centre of the reelable support member 10. The remainder of the plurality of composite strands 12, e.g. six composite strands, are wound around the core composite strand 14. The remainder of the composite strands 12 are left-hand helically wound, e.g. in an s-lay, around the core composite strand 14 at an angle of 10°. In other reelable support members, the remainder of the composite strands may be helically wound at an angle between 5° and 30°.

Interstitial spaces 16 are formed between the plurality of composite strands 12. The interstitial spaces 16 are filled with a filler matrix 18. The filler matrix 18 forms 5% of the reelable support member 10. The filler matrix 18 is formed of a polymer. The filler matrix 18 prevents migration of fluid (e.g. liquid and/or gas) along the reelable support member 10 via the interstitial spaces 16.

The reelable support member 10 further comprises a jacket 20. The jacket 20 is arranged around the plurality of composite strands 12, e.g. the jacket 20 circumscribes the plurality of composite strands 12. The jacket 20 is formed of polymer. The jacket 20 conforms to the shape of the wound composite strands, e.g. the jacket fills interstitial spaces outside of the wound composite strands 12. The jacket 20 has a smooth outer surface 22.

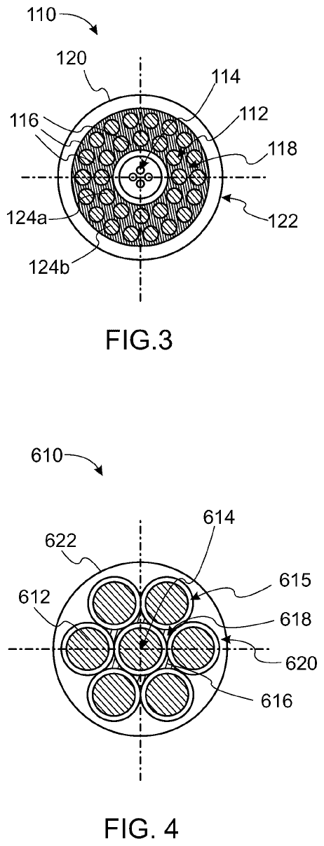

FIG. 3 shows another reelable support member 110. The reelable support member 110 comprises a plurality of composite strands 112. In particular, the reelable support member 110 comprises thirty composite strands 112. Other reelable support members may comprise more or less than thirty composite strands. Each composite strand has a tensile strength of at least 2100 MPa. Preferably, the tensile strength of each composite strand is between 2150 MPa and 2650 MPa.

Each composite strand 112 comprises a plurality of carbon fibre tows. The carbon fibre tows are unidirectional 12 k roving. Each carbon fibre tow has a strength of at least 4500 Mpa, a standard tensile modulus of up to 240 GPa, and breaking strain less than 2%. Each carbon fibre tow is right-hand twisted at an angle of 8°. In other reelable support members each carbon fibre tow may be twisted at an angle between 5° and 15°. Each composite strand 112 comprises fifteen carbon fibre tows. Each composite strand 112 has a diameter of 4.2 mm. In other reelable support members each composite strand may comprise more or less than fifteen carbon fibre tows. In other reelable support members each composite strand may have a diameter more or less than 4.2 mm. The diameter of each composite strand may be proportional to the number of carbon fibre tows comprised in the composite strand. Carbon fibre makes up 60% of the volume of each composite strand 112. In other reelable support member, the carbon fibre makes up between 55% and 70% of the volume of each composite strand 112. Each composite strand 112 further comprises epoxy in the form of a thermoset resin impregnated in the carbon fibre tows.

The reelable support member 110 comprises a functional core 114. The functional core 114 is configured to supply electrical power to a tool supported by the reelable support member 110 and to transmit real-time 2-way communication along the reelable support member 110. The functional core 114 comprises an optical fibre in a metal tube (FIMT). In other reelable support members, the functional core may comprise at least one of a metal core, a coaxial cable (coax), a hybrid coax-FIMT, a capillary metal tube, a multi conductor, a hybrid multi conductor-FIMT, a metal tube, a twisted pair, a polymer tube, etc. The functional core 114 is in the centre of the reelable support member 110. The plurality of composite strands 112 are wound around the functional core 114. In particular, the plurality of composite strands 112 are wound around the functional core 114 in two layers. Other reelable support members may have more or less than two layers. A first layer 124a of composite strands, comprising twelve composite strands of the plurality of composite strands 112, is helically wound around the functional core 114 in a first direction, e.g. in one of an s-lay or a z-lay. A second layer 124b of composite strands, comprising eighteen composite strands of the plurality of composite strands 112, is helically wound around the first layer 124a of composite strands in a second direction, e.g. in the other of an s-lay or a z-lay. Other reelable support members may have layers having other numbers of composite strands. The number of composite strands in each layer may depend on the diameter of the composite strands and the diameter of the core or the diameter of the radially inwardly adjacent layer of composite strands.

Interstitial spaces 116 are formed between the plurality of composite strands 112. The interstitial spaces 116 are filled with a filler matrix 118. The filler matrix 118 forms 5% of the reelable support member 110 The filler matrix 118 is formed of polymer, e.g. an elastomer. The filler matrix 118 is flexible. The filler matrix 118 prevents migration of fluid (e.g. liquid and/or gas) along the reelable support member 110 via the interstitial spaces 116.

The reelable support member 110 further comprises a jacket 120. The jacket 120 is arranged around the outer layer 124b of composite strands 112, e.g. the jacket 120 circumscribes the second layer 124b of composite strands. The jacket 120 is formed of polymer. Interstitial spaces 116 are also formed between the outer layer 124b of the composite strands 112 and the jacket 120. The interstitial spaces 116 between the outer layer 124b of the composite strands and the jacket 120 are also filled by the filler matrix 118. The jacket 120 surrounds the filler matrix 118. The jacket 120 has a smooth outer surface 122. In an alternative embodiment, the jacket may fill the interstitial spaces between the outer layer of the composite strands.

FIG. 4 shows another reelable support member 610. The reelable member 610 comprises a plurality of composite strands 612. In particular, the reelable support member 610 comprises seven composite strands. Other reelable support members may comprise more or less than seven composite strands. The number of composite strands may depend on the diameter of the composite strands.

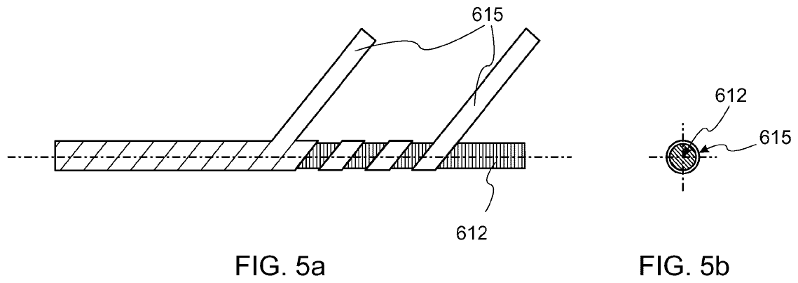

Each composite strand 612 comprises a plurality of carbon fibre tows. The carbon fibre tows are unidirectional 12 k roving. Each carbon fibre tow has a strength of at least 4500 Mpa, a standard tensile modulus of up to 240 GPa, and breaking strain less than 2%. Each carbon fibre tow is right-hand twisted at an angle of 8° (see FIG. 5a). In other reelable support members the each carbon fibre tow may be twisted at an angle between 5° and 15°. Each composite strand 612 comprises three carbon fibre tows. Each composite strand 612 has a diameter of 1.8 mm. In other reelable support members each composite strand may comprise more or less than three carbon fibre tows. In other reelable support members each composite strand may have a diameter more or less than 1.8 mm. The diameter of each composite strand may be proportional to the number of carbon fibre tows comprised in the composite strand. Each composite strand 612 further comprises epoxy in the form of a thermoset resin impregnated in the carbon fibre tows.

As shown in FIGS. 5a and 5b, each composite strand 612 has a protection layer 615 around it. The protection layer 615 is in the form of a fibre wrap. The fibre wrap 615 protects the composite strand. The fibre wrap 615 is left-hand helically wound, e.g. in an s-lay, around the composite strand 612.

Referring again to FIG. 4, one composite strand 612 of the plurality of composite strands forms a core 614 of the reelable support member 610. The core composite strand 614 is configured to transmit electrical signals for real-time 2-way communication along the reelable support member 610. The core composite strand 614 is in the centre of the reelable support member 610. The remainder of the plurality of composite strands 612, e.g. six composite strands, are wound around the core composite strand 614. The remainder of the composite strands 612 are right-hand helically wound, e.g. in a z-lay, around the core composite strand 614 at an angle of 10°. In other reelable support members, the remainder of the composite strands may be helically wound at an angle between 5° and 30°.

Interstitial spaces 616 are formed between the plurality of composite strands 612. The interstitial spaces 616 are filled with a filler matrix 618. The filler matrix 618 is formed of a polymer. The filler matrix 618 prevents migration of fluid (e.g. liquid and/or gas) along the reelable support member 610 via the interstitial spaces 616.

The reelable support member 610 further comprises a jacket 620. The jacket 620 is arranged around the plurality of composite strands 612, e.g. the jacket 620 circumscribes the plurality of composite strands 612. The jacket 620 is formed of polymer. The jacket 620 conforms to the shape of the wound composite strands, e.g. the jacket fills interstitial spaces outside of the wound composite strands 612. The jacket 620 has a smooth outer surface 622.

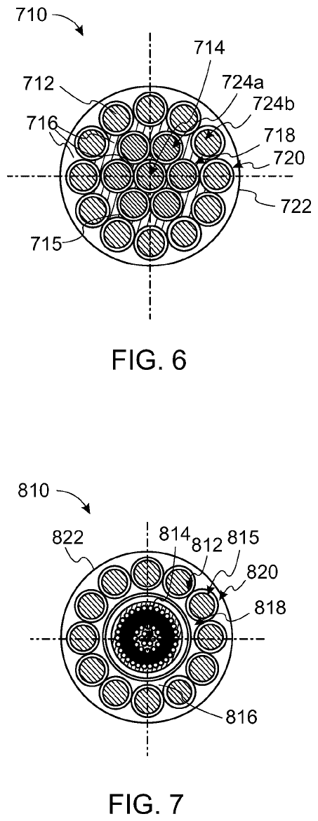

FIG. 6 shows another reelable support member 710. The reelable support member 710 comprises a plurality of composite strands 712. In particular, the reelable support member 710 comprises nineteen composite strands 712. Other reelable support members may comprise more or less than nineteen composite strands.

Each composite strand 712 comprises a plurality of carbon fibre tows. The carbon fibre tows are unidirectional 12 k roving. Each carbon fibre tow has a strength of at least 4500 Mpa, a standard tensile modulus of up to 240 GPa, and breaking strain less than 2%. Each carbon fibre tow is right-hand twisted at an angle of 8°. In other reelable support members each carbon fibre tow may be twisted at an angle between 5° and 15°. Carbon fibre makes up 60% of the volume of each composite strand 712. In other reelable support member, the carbon fibre makes up between 55% and 70% of the volume of each composite strand 712. Each composite strand 712 further comprises epoxy in the form of a thermoset resin impregnated in the carbon fibre tows. Each composite strand has a protection layer around it, in the form of a fibre wrap 715. The fibre wrap 715 protects each composite strand.

One composite strand 712 of the plurality of composite strands forms a core 714 of the reelable support member 710. The core composite strand 714 is configured to transmit electrical signals for real-time 2-way communication along the reelable support member 710. The core composite strand 714 is in the centre of the reelable support member 710. The remainder of the plurality of composite strands 712 are wound around the core composite strand 714. In particular, the remainder of the plurality of composite strands 712 are wound around the core composite strand 714 in two layers. Other reelable support members may have more or less than two layers. A first layer 724a of composite strands, comprising six composite strands of the plurality of composite strands 712, is helically wound around the functional core 714 in a first direction, e.g. a z-lay. A second layer 724b of composite strands, comprising twelve composite strands of the plurality of composite strands 712, is helically wound around the first layer 724a of composite strands in a second direction, e.g. in an s-lay. In other reelable support members, the first layer may be wound in an s-lay and the second layer may be wound in a z-lay. Other reelable support members may have layers having other numbers of composite strands. The number of composite strands in each layer may depend on the diameter of the composite strands and the diameter of the core or the diameter of the radially inwardly adjacent layer of composite strands.

Interstitial spaces 716 are formed between the plurality of composite strands 712. The interstitial spaces 716 are filled with a filler matrix 718. The filler matrix 718 is formed of polymer, e.g. an elastomer. The filler matrix 718 is flexible. The filler matrix 718 prevents migration of fluid (e.g. liquid and/or gas) along the reelable support member 710 via the interstitial spaces 716.

The reelable support member 710 further comprises a jacket 720. The jacket 720 is arranged around the outer layer 724b of composite strands 712, e.g. the jacket 320 circumscribes the second layer 724b of composite strands. The jacket 720 is formed of polymer. The jacket 720 conforms to the shape of the wound composite strands, e.g. the jacket fills interstitial spaces outside of the wound composite strands 712. The jacket 720 has a smooth outer surface 722.

FIG. 7 shows another reelable support member 810. The reelable member 810 comprises a plurality of composite strands 812. In particular, the reelable support member 810 comprises twelve composite strands. Other reelable support members may comprise more or less than twelve composite strands. The number of composite strands may depend on the diameter of the composite strands.

Each composite strand 812 comprises a plurality of carbon fibre tows. The carbon fibre tows are unidirectional 12 k roving. Each carbon fibre tow has a strength of at least 4500 MPa, a standard tensile modulus of up to 240 GPa, and breaking strain less than 2%. Each carbon fibre tow is right-hand twisted at an angle of 8°. In other reelable support members each carbon fibre tow may be twisted at an angle between 5° and 15°. Each composite strand 812 further comprises epoxy in the form of a thermoset resin impregnated in the carbon fibre tows. Each composite strand has a protection layer around it, in the form of a fibre wrap 815. The fibre wrap 815 protects each composite strand.

The reelable support member 810 comprises a functional core 814. The functional core 814 is configured to supply electrical power to a tool supported by the reelable support member 810 and to transmit real-time 2-way communication along the reelable support member 810. The functional core 814 comprises a coaxial cable (coax). In other reelable support members, the functional core may comprise at least one of a metal core, an optical fibre in a metal tube (FIMT), a hybrid coax-FIMT, a capillary metal tube, a polymer tube, a multi conductor, a hybrid multi conductor-FIMT, a metal tube, a twisted pair, etc. The functional core 814 is in the centre of the reelable support member 810. The plurality of composite strands 812 are wound around the functional core 814. The composite strands 812 are right-hand helically wound, e.g. in an z-lay, around the functional core 814 at an angle of 10°. In other reelable support members, the remainder of the composite strands may be helically wound at an angle between 5° and 30°.

An interstitial space 816 is formed between the plurality of composite strands 812 and the functional core 814. The interstitial space 816 is filled with a filler matrix 818. The filler matrix 818 is formed of a polymer, in particular a thermoplastic. The filler matrix 818 prevents migration of fluid (e.g. liquid and/or gas) along the reelable support member 810 via the interstitial space 816.

The reelable support member 810 further comprises a jacket 820. The jacket 820 is arranged around the plurality of composite strands 812, e.g. the jacket 820 circumscribes the plurality of composite strands 812. The jacket 820 is formed of polymer. The jacket 820 conforms to the shape of the wound composite strands, e.g. the jacket fills interstitial spaces outside of the wound composite strands 812. The jacket 820 has a smooth outer surface 822.

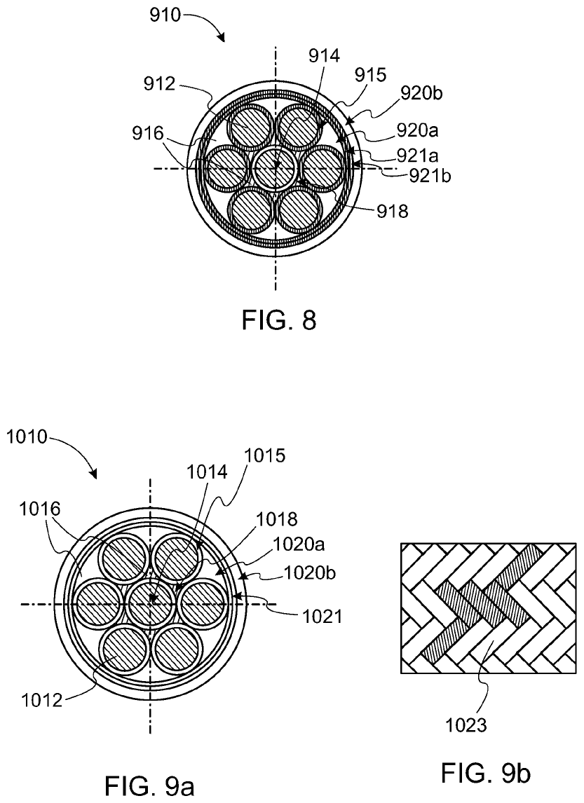

FIG. 8 shows another reelable support member 910. The reelable support member 910 comprises a plurality of composite strands 912. In particular, the reelable support member 910 comprises seven composite strands. Other reelable support members may comprise more or less than seven composite strands. The number of composite strands may depend on the dimeter of the composite strands.

Each composite strands 912 comprises a plurality of carbon fibre tows. The carbon fibre tows are unidirectional 12 k roving. Each carbon fibre tow has a strength of at least 4500 MPa, a standard tensile modulus of up to 240 GPa, and breaking strain less than 2%. Each carbon fibre tow is right-hand twisted at an angle of 8°. In other reelable support members each carbon fibre tow may be twisted at an angle between 5° and 15°. Each composite strand 912 further comprises epoxy in the form of a thermoset resin. The thermoset resin is impregnated in the carbon fibre tows. Each composite strand has a protection layer around it, in the form of a fibre wrap 915. The fibre wrap 915 protects each composite strand.

One composite strand 912 of the plurality of composite strands 912 forms a core 914 of the reelable support member 910. The core composite strand 914 is configured to transmit electrical signals for real-time 2-way communication along the reelable support member 910. The core composite strand 914 is in the centre of the reelable support member 910. The remainder of the plurality of composite strands 912, e.g. six composite strands, are wound around the core composite strand 914. The remainder of the composite strands 912 are right-hand helically wound, e.g. in a z-lay, around the core composite strand 914 at an angle of 10°. In other reelable support members, the remainder of the composite strands may be helically wound at an angle between 5° and 30°.

Interstitial spaces 916 are formed between the plurality of composite strands 912. The interstitial spaces 916 are filled with a filler matrix 918. The filler matrix 918 is formed of a polymer. The filler matrix 918 prevents migration of fluid (e.g. liquid and/or gas) along the reelable support member 910 via the interstitial spaces 916.

The reelable support member 910 further comprises an inner jacket 920a. The jacket 920a conforms to the shape of the wound composite strands, e.g. the inner jacket 920a fills interstitial spaces outside of the wound composite strands 912. The inner jacket 920a is formed of polymer.

The reelable support member 910 further comprises a first support layer 921a and a second support layer 921b. The support layers 921 protect the composite strands 912 from impact loads and add hoop strength to the reelable support member 910. The first and second support layers 921 are formed of thermoplastic unidirectional fibre reinforced tape. The thermoplastic unidirectional fibre reinforced tape is melt fused. The tape of the first support layer 921a is wound around the inner jacket 920a in an s-lay at 50°. The tape of the second support layer 921b is wound around the first support layer 921a in a z-lay at 50°. In other embodiments there may be a single support layer, or there may be more than two support layers. In other embodiments the winding direction and/or angle of the support layer(s) may be different.

The reelable support member 910 further comprises an outer jacket 920b. The outer jacket 920b is arranged around the support layers 921, e.g. the outer jacket 920b circumscribes the second support layer 921b. The outer jacket 920b is formed of polymer. The outer jacket 920b has a smooth outer surface 922.

FIG. 9a shows a reelable support member 1010. The reelable support member 1010 comprises a plurality of composite strands 1012. In particular, the reelable support member 1010 comprises seven composite strands. Other reelable support members may comprise more or less than seven composite strands. The number of composite strands may depend on the dimeter of the composite strands.

Each composite strands 1012 comprises a plurality of carbon fibre tows. The carbon fibre tows are unidirectional 12 k roving. Each carbon fibre tow has a strength of at least 4500 MPa, a standard tensile modulus of up to 240 GPa, and breaking strain less than 2%. Each carbon fibre tow is right-hand twisted at an angle of 8°. In other reelable support members each carbon fibre tow may be twisted at an angle between 5° and 15°. Each composite strand 1012 further comprises epoxy in the form of a thermoset resin. The thermoset resin is impregnated in the carbon fibre tows. Each composite strand has a protection layer around it, in the form of a fibre wrap 1015. The fibre wrap 1015 protects each composite strand.

One composite strand 1012 of the plurality of composite strands 1012 forms a core 1014 of the reelable support member 1010. The core composite strand 1014 is configured to transmit electrical signals for real-time 2-way communication along the reelable support member 1010. The core composite strand 1014 is in the centre of the reelable support member 1010. The remainder of the plurality of composite strands 1012, e.g. six composite strands, are wound around the core composite strand 1014. The remainder of the composite strands 1012 are right-hand helically wound, e.g. in a z-lay, around the core composite strand 1014 at an angle of 10°. In other reelable support members, the remainder of the composite strands may be helically wound at an angle between 5° and 30°.

Interstitial spaces 1016 are formed between the plurality of composite strands 1012. The interstitial spaces 1016 are filled with a filler matrix 1018. The filler matrix 1018 is formed of a polymer. The filler matrix 1018 prevents migration of fluid (e.g. liquid and/or gas) along the reelable support member 910 via the interstitial spaces 1016.

The reelable support member 1010 further comprises an inner jacket 1020a. The jacket 1020a conforms to the shape of the wound composite strands, e.g. the inner jacket 1020a fills interstitial spaces outside of the wound composite strands 1012. The inner jacket 1020a is formed of polymer.

The reelable support member 1010 further comprises a support layer 1021. The support layer 1021 protects the composite strands 1012 from impact loads and adds hoop strength to the reelable support member 1010. The support layer 1021 is formed of braided fibres 1023, as shown in FIG. 9b. The support layer 1021 has a 3 over 3 braid pattern of the fibres 1023. The fibres 1023 are braded at an angle of 50°. The fibres are formed of Technora®. Other braded support members may be formed of other synthetic fibres such such Kevlar®, Vectran™, Glass or Basalt. Alternatively, other braided support members may be formed of metallic fibres such as high strength steel wire, stainless steel wire, copper alloy wire, etc.

The reelable support member 1010 further comprises an outer jacket 1020b. The outer jacket 1020b is arranged around the support layer 1021, e.g. the outer jacket 1020b circumscribes the support layer 1021b. The outer jacket 1020b is formed of polymer. The outer jacket 1020b has a smooth outer surface 1022. The support layer 1021 is embedded between the inner and outer polymer jackets.

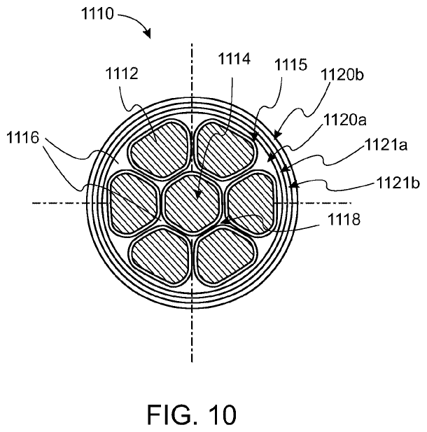

FIG. 10 shows another reelable support member 1110. The reelable support member 1110 comprises a plurality of composite strands 1112. In particular, the reelable support member 1110 comprises seven composite strands. Other reelable support members may comprise more or less than seven composite strands. The number of composite strands may depend on the dimeter of the composite strands.

Each composite strands 1112 comprises a plurality of carbon fibre tows. The carbon fibre tows are unidirectional 12 k roving. Each carbon fibre tow has a strength of at least 4500 MPa, a standard tensile modulus of up to 240 GPa, and breaking strain less than 2%. Each carbon fibre tow is right-hand twisted at an angle of 8°. In other reelable support members each carbon fibre tow may be twisted at an angle between 5° and 15°. Each composite strand 1112 further comprises epoxy in the form of a thermoset resin. The thermoset resin is impregnated in the carbon fibre tows.

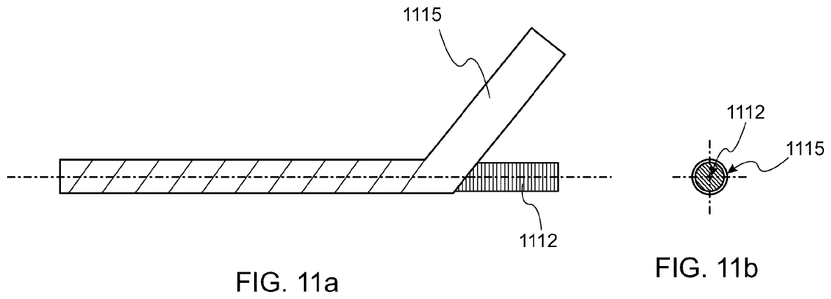

As shown in FIGS. 11a and 11b, each composite strand 1112 has a protection layer around it in the form of a wrap 1115. The wrap 1115 comprises thermoplastic unidirectional fibre reinforced tape. The wrap 1115 is left-hand helically wound, e.g. in an s-lay, around the composite strand 1112.

One composite strand 1112 of the plurality of composite strands 1112 forms a core 1114 of the reelable support member 1110. The core composite strand 1114 is configured to transmit electrical signals for real-time 2-way communication along the reelable support member 1110. The core composite strand 1114 is in the centre of the reelable support member 1110. The remainder of the plurality of composite strands 1112, e.g. six composite strands, are wound around the core composite strand 1114. The remainder of the composite strands 1112 are right-hand helically wound, e.g. in a z-lay, around the core composite strand 1114 at an angle of 10°. In other reelable support members, the remainder of the composite strands may be helically wound at an angle between 5° and 30°.

The composite strands 1112 are formed and compacted, and thus each composite strand has an irregular, e.g. non-circular, cross sectional shape.

Interstitial spaces 1116 are formed between the plurality of composite strands 1112. The interstitial spaces 916 are filled with a filler matrix 1118. The filler matrix 1118 is formed of melt fused thermoplastic unidirectional fibre reinforced tape. The filler matrix 1118 prevents migration of fluid (e.g. liquid and/or gas) along the reelable support member 1110 via the interstitial spaces 1116.

The reelable support member 1110 further comprises an inner jacket 1120a. The jacket 1120a conforms to the shape of the wound composite strands, e.g. the inner jacket 1120a fills interstitial spaces outside of the wound composite strands 1112. The inner jacket 1120a is formed of polymer.

The reelable support member 1110 further comprises a first support layer 1121a and a second support layer 1121b. The support layers 1121 protect the composite strands 1112 from impact loads and add hoop strength to the reelable support member 1110. The first and second support layers 1121 are formed of thermoplastic unidirectional fibre reinforced tape. The thermoplastic unidirectional fibre reinforce tape is melt fused. The tape of the first support layer 1121a is wound around the inner jacket 1120a in an s-lay at 50°. The tape of the second support layer 1121b is wound around the first support layer 1121a in a z-lay at 50°. In other embodiments there may be a single support layer, or there may be more than two support layers. In other embodiments the winding direction and/or angle of the support layer(s) may be different.

The reelable support member 1110 further comprises an outer jacket 1120b. The outer jacket 1120b is arranged around the support layers 1121, e.g. the outer jacket 1120b circumscribes the second support layer 1121b. The outer jacket 1120b is formed of polymer. The outer jacket 1120b has a smooth outer surface 1122.

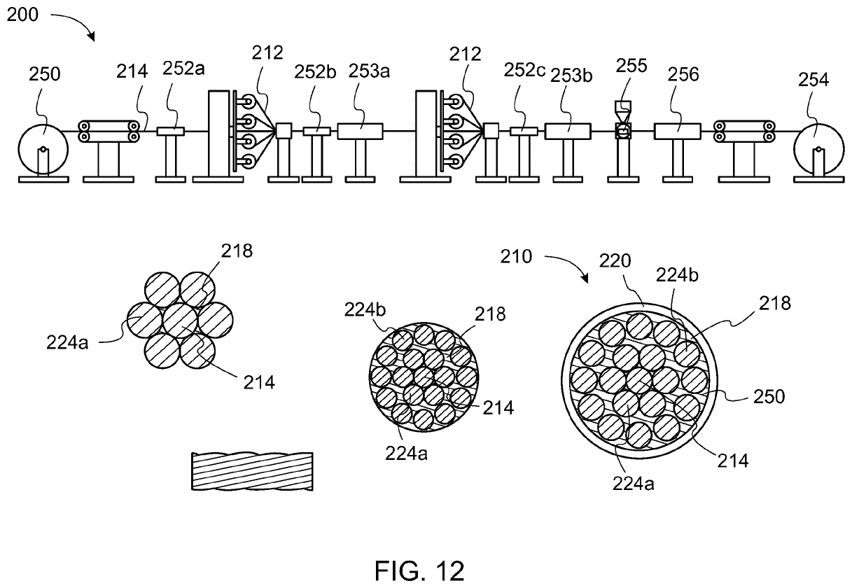

FIG. 12 shows a schematic of a first manufacturing line 200 for manufacturing a reelable support member 210. The reelable support member 210 is constructed in layers. Transverse cross-sections of the reelable support member 210 as the layers are applied are shown in FIG. 12 adjacent the associated operation in the manufacturing line 200. A core 214 is fed onto the line from an input reel 250. The core 214 is a composite strand 212. In other manufacturing methods the core may be a functional core, e.g. a metal core, a fibre optic in a metal tube (FIMT), a coaxial cable (coax), a hybrid coax-FIMT, a capillary metal tube, a multi conductor, a hybrid multi conductor-FIMT, a twisted pair, a metal tube, a polymer tube, etc.

The core 214 is run through a first bath 252a of filler matrix material 218. The filler matrix material 218 is formed of a thermoset polymer. Excess filler matrix material 218 is wiped from the core 214 on exit from the first bath 252a.

A plurality of composite strands 212 are wound, e.g. helically wound, around the core 214 to form a first layer 224a of composite strands 212 around the core 214. The first layer of composite strands are run through a second bath 252b of filler matrix material 218. Excess filler matrix material 218 is wiped from the first layer 224a of composite strands 212 on exit from the second bath 252b.

All of the composite strands 212 in the reelable support member 210 are prepreg semi-cured composite strands. Each composite strand 212 comprises a plurality of carbon fibre tows. The carbon fibre tows are 12 k unidirectional roving. Each carbon fibre tow has a strength of at least 4500 Mpa, a standard tensile modulus of up to 240 GPa, and breaking strain less than 2%. Each carbon fibre tow is right-hand twisted at an angle of 8°. In other composite strands for manufacturing a reelable support member the each carbon fibre tow may be twisted at an angle between 5° and 15°. Each composite strand 212 comprises at least fifteen carbon fibre tows. Carbon fibre makes up 60% of the volume of each composite strand 212. In other composite strands for a reelable support member, the carbon fibre makes up between 55% and 70% of the volume of each composite strand. Each composite strand 212 further comprises epoxy. The epoxy is in the form of a thermoset resin. The epoxy resin is impregnated into the carbon fibre tows.

After winding the first layer 224a of composite strands 212 around the core and applying the filler matrix material 218, a first curing operation is carried out, by running the composite strands 212 and filler matrix material 218 through a first heater 253a, to cure the filler matrix material 218 applied to the composite strands 212, and to fully cure the first layer 224a of prepreg semi-cured composite strands 212 and the core prepreg semi-cured composite strand 214.

A further plurality of composite strands 212 are wound, e.g. helically wound, around the first layer 224a of composite strands 212 to form a second layer 224b of composite strands 212. The second layer 224b of composite strands 212 are run through a third bath 252c of filler matrix material 218. Excess filler matrix material 218 is wiped from the second layer 224b of composite strands 212 on exit from the third bath 252c.

After winding the second layer 224b of composite strands 212 around the first layer 224a of composite strands 212 and applying the filler matrix material 218, a second curing operation is carried out, by running the composite strands 212 and filler matrix material 218 through a second heater 253b, to cure the filler matrix material 218 applied to the composite strands 212, and to fully cure the second layer 224b of composite strands 212.

The second layer of composite strands 212 is then jacketed with a polymer jacket 220 via a jacketing apparatus 255, e.g. a polymer jacket 220 is arranged around the second layer 224b of composite strands 212 to form an outer layer of the reelable support member 210. The polymer jacket 220 is formed of a thermoplastic polymer.

The fully constructed reelable support member 210 undergoes a crosslinking treatment via a crosslinking apparatus 256, e.g. an irradiation electro-beam crosslinking apparatus, as is known in the art. In an alternative manufacturing method the crosslinking treatment, or any other post-curing treatment, may be carried out on a separate manufacturing line.

The completed, e.g. fully assembled, reelable support member 210 is wound onto an output reel 254 for storage, transportation and deployment.

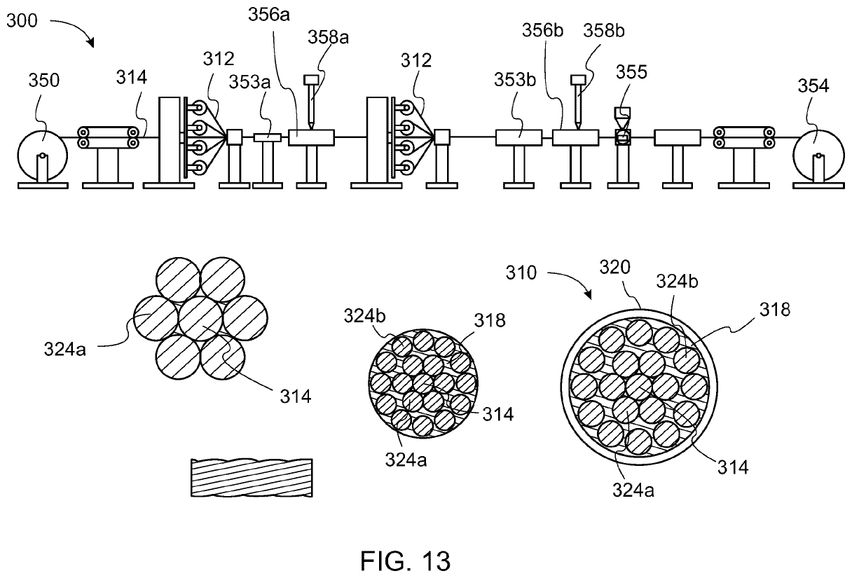

FIG. 13 shows a schematic of a second manufacturing line 300 for manufacturing a reelable support member 310. The reelable support member 310 is constructed in layers. Cross sections of the reelable support member 310 as the layers are applied are shown in FIG. 13 adjacent the associated operation in the manufacturing line 300. A core 314 is fed onto the line from an input reel 350. The core 314 is a composite strand 312. In other manufacturing methods the core may be a functional core, e.g. a metal core, a fibre optic in a metal tube (FIMT), a coaxial cable (coax), a hybrid coax-FIMT, a capillary metal tube, a multi conductor, a hybrid multi conductor-FIMT, a twisted pair, a metal tube, a polymer tube, etc.

A plurality of composite strands 312 are wound, e.g. helically wound, around the core 314 to form a first layer 324a of wound composite strands 312. All of the composite strands 312 are prepreg semi-cured composite strands. Each composite strand 312 comprises a plurality of carbon fibre tows. The carbon fibre tows are 12 k unidirectional roving. Each carbon fibre tow has a strength of at least 4500 Mpa, a standard tensile modulus of up to 240 GPa, and breaking strain less than 2%. Each carbon fibre tow is right-hand twisted at an angle of 8°. In other composite strands for manufacturing a reelable support member each carbon fibre tow may be twisted at an angle between 5° and 15°. Each composite strand 312 comprises at least fifteen carbon fibre tows. Carbon fibre makes up 60% of the volume of each composite strand 312. In other composite strands for manufacturing a reelable support member, the carbon fibre makes up between 55% and 70% of the volume of each composite strand. Each composite strand 312 further comprises epoxy. The epoxy is in the form of a thermoset resin. The epoxy is impregnated in the carbon fibre tows. After winding the first layer 324a of composite strands 312 around the core, a first curing operation is carried out by running the composite strands 312 and through a first heater 353a, to fully cure the first layer 324a of composite strands 312.

After the first layer 324a of composite strands 312 has been wound and cured, a first rotating caterpillar 356a is used to temporarily open the plurality of composite strands 312 of the first layer 324a. Opening the plurality of composite strands 312 involves twisting the composite strands 312 against their helical winding via the first rotating caterpillar 356a so that the composite strands 312 spread apart from each other. While the composite strands 312 are open, e.g. spread apart from each other, filler matrix material 318 is injected between the composite strands 312 by a first injector 358a, e.g. a piston pump or an extruder. The filler matrix material 318 is formed of a polymer, e.g. an elastomer. After the filler matrix material 318 has been injected between the composite strands 312, the composite strands 312 are returned to their helically wound configuration by the first rotating caterpillar 356a.

A further plurality of composite strands 312 are wound, e.g. helically wound, around the first layer 324a of composite strands 312 to form a second layer 324b of composite strands 312. After winding the second layer 324b of composite strands 312 around the first layer 324a of composite strands 312, a second curing operation is carried out, by running the composite strands 312 and through a second heater 353b, to fully cure the second layer 324b of composite strands 312.

After the second layer 342b of composite strands 312 have been wound and cured, a second rotating caterpillar 356b is used to temporarily open the plurality of composite strands 312 of the second layer 342b. While the composite strands 312 are open, e.g. spread apart from each other, filler matrix material 318 is injected between the composite strands 312 by a second injector 358b, e.g. a piston pump or an extruder. After the filler matrix material 318 has been injected between the composite strands 312, the composite strands 312 are returned to their helically wound configuration by the second rotating caterpillar 356b.

After applying the filler matrix material 318 between the plurality of composite strands 312 of the second layer 324b, the second layer 324b of composite strands 312 is jacketed with a polymer jacket 320 via a jacketing apparatus 355, e.g. a polymer jacket 320 is arranged around the second layer 324b of composite strands 312 to form an outer layer of the reelable support member 310. The completed reelable support member 310 is wound onto an output reel 354 for storage, transportation and deployment.

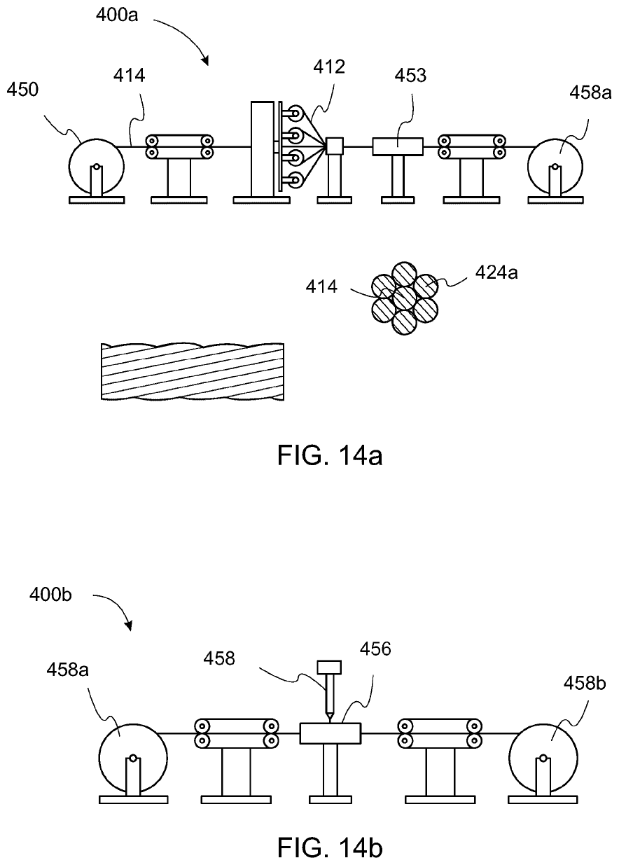

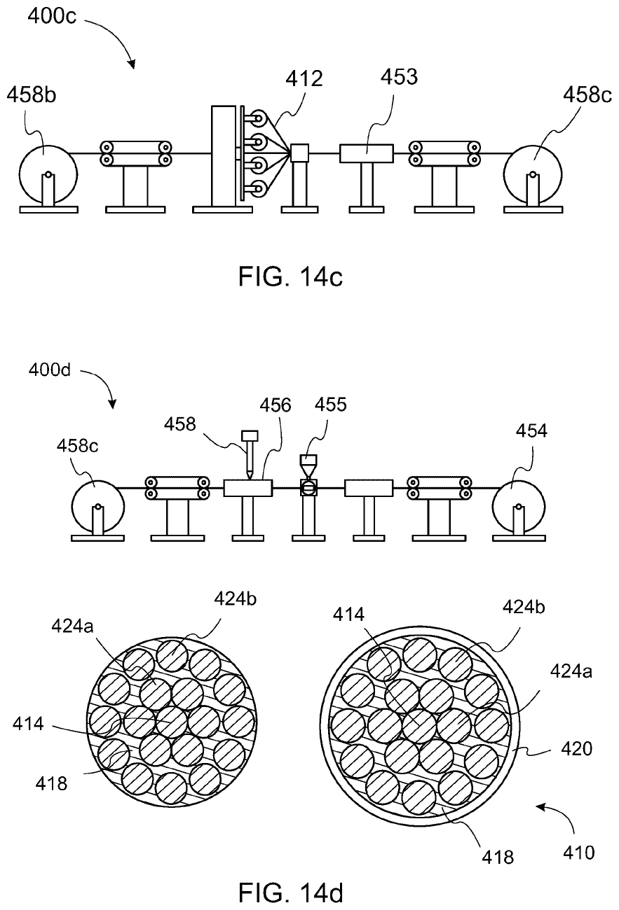

FIGS. 14a to 14d show four schematic manufacturing lines 400a, 400b, 400c, 400d for manufacturing a reelable support member 410. The method of manufacturing the reelable support member 410 substantially corresponds to the method of manufacturing reelable support member 310, with the method being executed in multiple stages on the first manufacturing line 400a, the second manufacturing line 400b, the third manufacturing line 400c and the fourth manufacturing line 400d. An intermediary cable is output from the first manufacturing line 400a to a first intermediary reel 458a for storage, transportation and deployment onto the second manufacturing line 400b. An intermediary cable is output from the second manufacturing line 400b to a second intermediary reel 458b for storage, transportation and deployment onto the third manufacturing line 400c. An intermediary cable is output from the third manufacturing line 400c to a third intermediary reel 458c for storage, transportation and deployment onto the fourth manufacturing line 400d.

The reelable support member is constructed in layers. Transverse cross-sections of the reelable support member 410 as the layers are applied are shown in FIGS. 5a and 5d adjacent the associated operation in the manufacturing lines 400a, 400d.

A core 414 is fed onto the first line 400a from an input reel 450. The core 414 is a composite strand 412. In other manufacturing methods the core may be a functional core, e.g. a metal core, a fibre optic in a metal tube (FIMT), a coaxial cable (coax), a hybrid coax-FIMT, a capillary metal tube, a multi conductor, a hybrid multi conductor-FIMT, polymer tube, metal tube, twisted pair, etc.

A plurality of composite strands 412 are wound, e.g. helically wound, around the core 414 to form a first layer 424a of composite strands 412 around the core 414. All of the composite strands 412 are prepreg semi-cured composite strands. Each composite strand 412 comprises a plurality of carbon fibre tows. The carbon fibre tows are 12 k unidirectional roving. Each carbon fibre tow has a strength of at least 4500 MPa, a standard tensile modulus of up to 240 GPa, and breaking strain less than 2%. Each carbon fibre tow is right-hand twisted at an angle of 8°. In other composite strands for manufacturing a reelable support member each carbon fibre tow may be twisted at an angle between 6° and 10°. Each composite strand 412 comprises at least fifteen carbon fibre tows. Carbon fibre makes up 60% of the volume of each composite strand 412. In other composite strands for manufacturing a reelable support member, the carbon fibre makes up between 55% and 70% of the volume of each composite strand. Each composite strand 412 further comprises epoxy. The epoxy is in the form of a thermoset resin. The epoxy is impregnated in the carbon fibre tows After winding the first layer 424a of composite strands 412 around the core, a curing operation is carried out, by running the composite strands 412 and through a heater 453, to fully cure the first layer 424a of composite strands 412. The intermediary cable comprising the core 414 and the first layer of composite strands 412 is wound onto the first intermediary reel 458a for storage, transportation and deployment, thus concluding the first manufacturing line 400a of the manufacturing method.

The intermediary cable is fed from the first intermediary reel 458a onto the second manufacturing line 400b. A rotating caterpillar 456 is used to temporarily open the plurality of composite strands 412 of the first layer 424a. Opening the plurality of composite 412 strands involves twisting the composite strands 412 against their helical winding via the rotating caterpillar 456 so that the composite strands 412 spread apart from each other. While the composite strands 412 are open, e.g. spread apart from each other, filler matrix material 418 is injected between the composite strands 412 by an injector 458, e.g. a piston pump or an extruder. The filler matrix material 418 is formed of a polymer, e.g. an elastomer. After the filler matrix material 418 has been injected between the composite strands 412, the composite strands 412 are returned to their helically wound configuration by the rotating caterpillar 456. The intermediary cable comprising the core 414, the first layer 424a of composite strands 412 and the filler matrix material 418 is wound onto the second intermediary reel 458b for storage, transportation and deployment, thus concluding the second manufacturing line 400b of the manufacturing method.

The intermediary cable is fed from the second intermediary reel 458b onto the third manufacturing line 400c. A further plurality of composite strands 412 are wound, e.g. helically wound, around the first layer 424a of composite strands 412 to form a second layer 424b of composite strands 412. After winding the second layer 424b of composite strands 412 around the first layer 424a of composite strands 412, a curing operation is carried out, by running the composite strands 412 and through a heater 453, to fully cure the second layer 424b of composite strands 412. The intermediary cable comprising the core 414, the first layer 424a of composite strands 412, the filler matrix material 418 and the second layer 424b of composite strands 412 is wound onto the third intermediary reel 458c for storage, transportation and deployment, thus concluding the third manufacturing line 400c of the manufacturing method.

The intermediary cable is fed from the third intermediary reel 458a onto the fourth manufacturing line 400d. A rotating caterpillar 456 is used to temporarily open the plurality of composite strands 412 of the second layer 424b. Opening the plurality of composite 412 strands involves twisting the composite strands 412 against their helical winding via the rotating caterpillar 456 so that the composite strands 412 spread apart from each other. While the composite strands 412 are open, e.g. spread apart from each other, filler matrix material 418 is injected between the composite strands 412 by an injector 458, e.g. a piston pump or an extruder. The filler matrix material 418 is formed of a polymer, e.g. an elastomer. After the filler matrix material 418 has been injected between the composite strands 412, the composite strands 412 are returned to their helically wound configuration by the rotating caterpillar 456.

After applying the filler matrix material 418 between the plurality of composite strands 412, the second layer 424b of composite strands 412 is jacketed with a polymer jacket 420 via a jacketing apparatus 455, e.g. a polymer jacket 420 is arranged around the second layer 424a of composite strands 412 to form an outer layer of the reelable support member 410. The completed reelable support member 410 is wound onto an output reel 454 for storage, transportation and deployment.

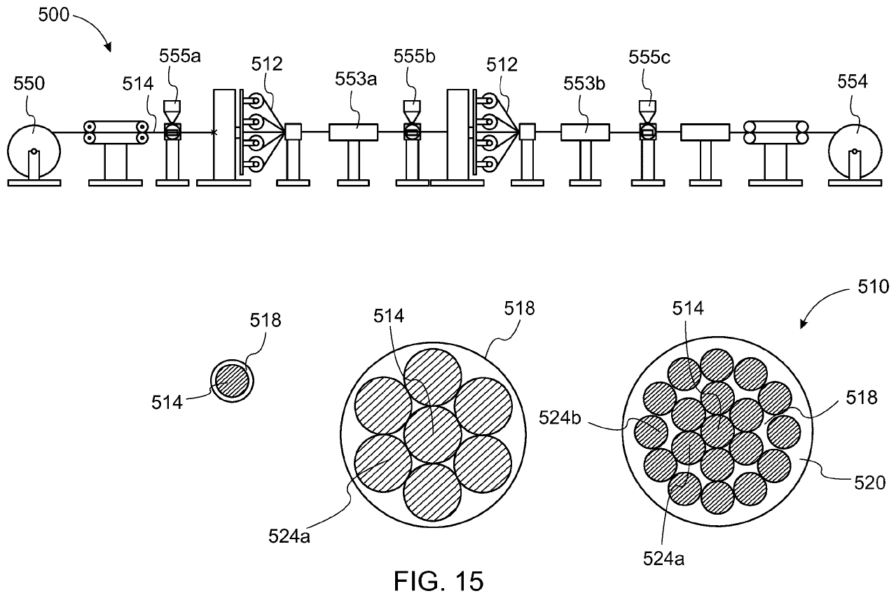

FIG. 15 shows another schematic manufacturing line 500 for manufacturing a reelable support member 510. The reelable support member 510 is constructed in layers. Transverse cross-sections of the reelable support member 510 as the layers are applied are shown in FIG. 15 adjacent the associated operation in the manufacturing line 500. A core 514 is fed onto the line from an input reel 550. The core 514 is a composite strand 512. In other manufacturing methods the core may be a functional core, e.g. a metal core, a fibre optic in a metal tube (FIMT), a coaxial cable (coax), a hybrid coax-FIMT, a capillary metal tube, a multi conductor, a hybrid multi conductor-FIMT, metal tube, twisted pair, a polymer tube, etc.

The core 514 is jacketed with filler matrix material 518 via a first jacketing apparatus 555a, e.g. the core 514 is surrounded by filler matrix material 518 to form a first jacket of filler matrix material 518. The filler matrix material 518 is formed of a thermoplastic polymer, e.g. a thermoplastic fluoro polymer.

A plurality of composite strands 512 are wound, e.g. helically wound, around the first jacket of filler matrix material 518 to form a first layer 524a of wound composite strands 512. During the stranding operation the filler matrix material 518 is heated, e.g. by a heater, to melt the filler matrix material 518 so that the composite strands 512 become embedded in the filler matrix material 518.

All of the composite strands 512 are prepreg semi-cured composite strands. Each composite strand 512 comprises a plurality of carbon fibre tows. The carbon fibre tows are 12 k unidirectional roving. Each carbon fibre tow has a strength of at least 4500 Mpa, a standard tensile modulus of up to 240 GPa, and breaking strain less than 2%. Each carbon fibre tow is right-hand twisted at an angle of 8°. In other composite strands for manufacturing a reelable support member each carbon fibre tow may be twisted at an angle between 5° and 15°. Each composite strand 512 comprises at least fifteen carbon fibre tows. Carbon fibre makes up 60% of the volume of each composite strand 512. In other composite strands for manufacturing a reelable support member, the carbon fibre makes up between 55% and 70% of the volume of each composite strand. Each composite strand 512 further comprises epoxy. The epoxy is in the form of a thermoset resin. The epoxy is impregnated in the carbon fibre tows. After winding the first layer 524a of composite strands 512 around the first jacket of filler matrix material 518, a first curing operation is carried out, by running the first layer 524a of composite strands 512 through a heater 553a, to fully cure the first layer 524a of composite strands 512.

The first layer 524a of composite strands 524 is jacketed with filler matrix material 518 by a second jacketing apparatus 555b, e.g. the first layer 524a of composite strands 524 is surrounded by filler matrix material 518 to form a second jacket of filler matrix material 518.

A plurality of composite strands 512 are wound, e.g. helically wound, around the second jacket of filler matrix material 518 to form a second layer 524b of wound composite strands 512. During the stranding operation the filler matrix material 518 is heated, e.g. by a heater, to melt the filler matrix material 518 so that the composite strands 512 become embedded in the filler matrix material 518.

After winding the second layer 524b of composite strands 512 around the second jacket of filler matrix material 518, a second curing operation is carried out, by running the composite strands 512 and through a heater 553b, to fully cure the second layer 524b of composite strands 512.

After curing the second layer 524b of composite strands 512, the second layer 524b of composite strands 512 is jacketed with a polymer jacket 520 by a third jacketing apparatus 555c, e.g. a polymer jacket 520 is arranged around the second layer 524b of composite strands 512 to form an outer layer of the reelable support member 510. The polymer jacket 520 is formed of the same thermoplastic fluoro polymer material as the filler matrix material 518. The polymer jacket 520 and the filler matrix material 518 both comprise Ethylene tetrafluoroethylene (ETFE). In an alternative reelable support member the jacket and the filler matrix material may both comprise or be formed of mPEEK, ECTFE or PTFE. The completed reelable support member 510 is wound onto an output reel 554 for storage, transportation and deployment.

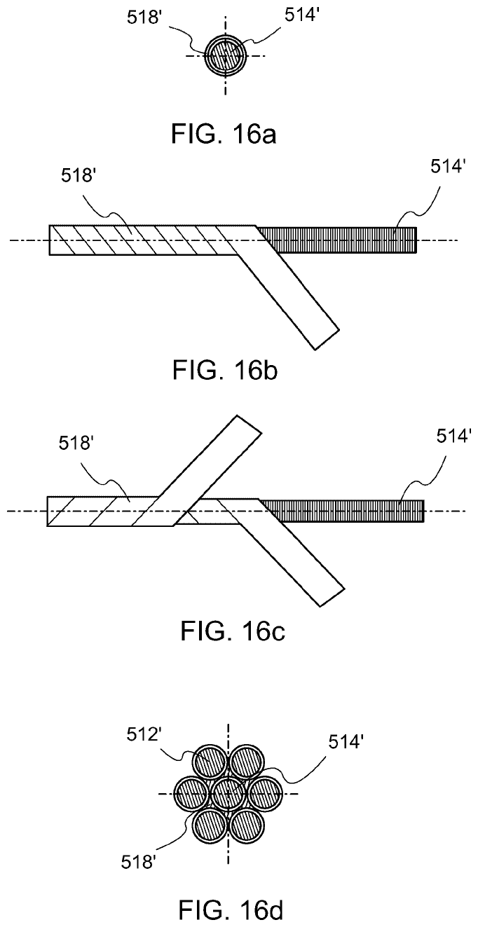

A modified version of the manufacturing process of FIG. 15, is shown with reference to FIGS. 16a-d. The filler matrix material 518′ can be wrapped around the core 514′ rather than applied as a jacket. The filler matrix material 518′ can be in the form of tape and/or monofilament. Where both tape and monofilament are used, the tape can be wrapped around the core to seal the core, and the monofilament can be wrapped on top of the tape to fill or substantially fill the interstitial spaces. The tape and/or monofilament can be formed of or comprise PTFE. The PTFE quality can be low density expanded PTFE or a full density PTFE. The PTFE can have a density between 0.4 g/cm³ and 1.6 g/cm³. The PTFE can have a tensile strength >6 MPa. The PTFE can have an elongation >40%. Where tape is used, the dimensions of the tape depend on the diameter of the composite strands 512′. The tape has a width between 2 mm to 10 mm. Where only tape is used, the dimensions of the tape depend on the volume of filler matrix material 518′ needed to fill between the core 514′ and the composite strands 512′, e.g. to fill the interstitial spaces. The tape has a thickness between 0.1 mm to 0.2 mm. The tape has a single splice free length of up to 20000 m. The tape can be wrapped around the core 514′ using a cable taping machine. As shown in FIG. 16b, the tape can be applied in a single wrap with a 50% overlap. Alternatively, as shown in FIG. 16c, the tape can be applied in a dual cross wrap with between 0 and 50% overlap. After the core 514′ is wrapped with filler matrix material 518′, the core 514′ is pulled through a die to calibrate the outer diameter of the core 514′ and the thickness of the filler matrix material 518′. Then a layer of composite strands 512′ are wrapped around the core 514′, as shown in FIG. 16d. After the composite strands 512′ are wrapped around the core 514′, the assembled composite strands 512′ and core 514′ are pulled through a die to calibrate the outer diameter of the composite strands 512′ and to push the outer strands 512′ into the filler matrix material 518′. The filler matrix material 518′ will be deformed as the composite strands 512′ are pushed into it.

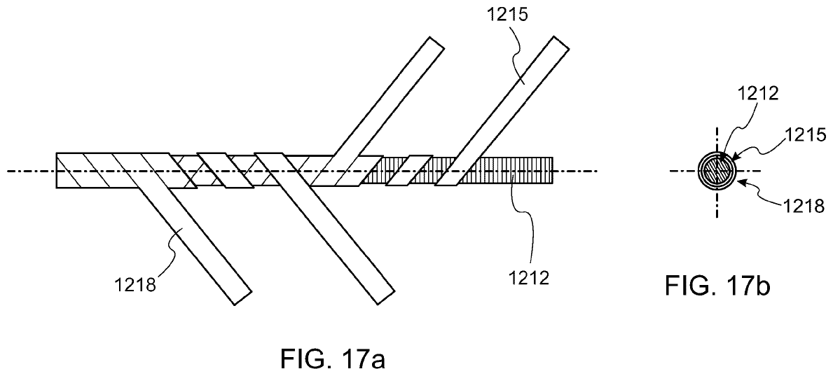

As an alternative to the manufacturing process of FIG. 15, the filler matrix material can be introduced into the reelable support member via a thermoplastic layer around each composite strand. After winding the plurality of composite strands onto the core, the thermoplastic layers of the composite strands are melt fused together. The thermoplastic layers can be melt fused via an induction coil heater or an infrared heater. The melt fusing process can be carried out in parallel with the composite strand curing process. Examples of composite strands for use in this manufacturing process are shown in FIGS. 17a to 19b.

The composite strand 1212 of FIGS. 17a and 17b comprises a plurality of right-hand twisted carbon fibre tows pre-impregnated with epoxy. The composite strand 1212 has a protection layer around it, in the form of a multifilament wrap 1215. The multifilament wrap 1215 is left-hand wrapped, e.g. in an s-lay, around the composite strand 1212. The protection layer has a thermoplastic layer around it, in the form of a thermoplastic yarn wrap 1218. The thermoplastic yarn wrap 1218 is right-hand wrapped, e.g. in a z-lay, around the multifilament wrap 1215.

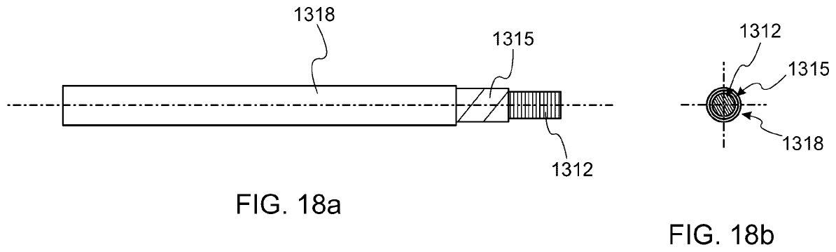

The composite strand 1312 of FIGS. 18a and 18b comprises a plurality of right-hand twisted carbon fibre tows pre-impregnated with epoxy. The composite strand 1312 has a protection layer around it, in the form of a multifilament wrap 1315. The multifilament wrap 1315 is left-hand wrapped, e.g. in an s-lay, around the composite strand 1312. The protection layer has a thermoplastic layer around it, in the form of a thermoplastic jacket 1318.

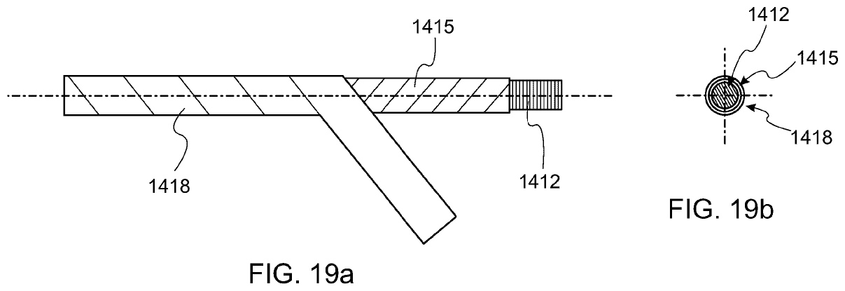

The composite strand 1412 of FIGS. 19a and 19b comprises a plurality of right-hand twisted carbon fibre tows pre-impregnated with epoxy. The composite strand 1412 has a protection layer around it, in the form of a multifilament wrap 1415. The multifilament wrap 1415 is left-hand wrapped, e.g. in an s-lay, around the carbon fibre tows. The protection layer has a thermoplastic layer around it, in the form of a thermoplastic tape wrap 1418.

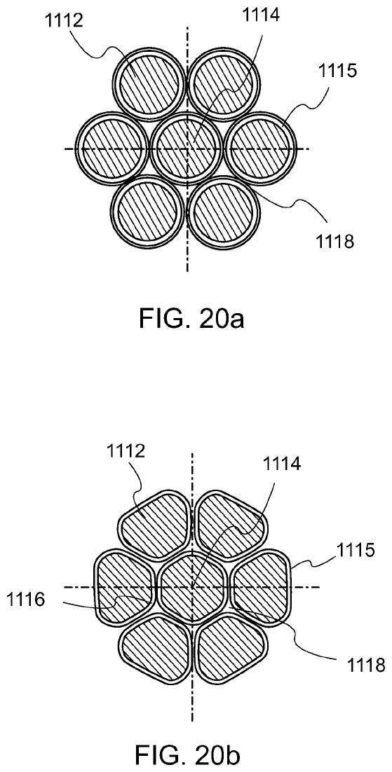

Methods of manufacturing a reelable support member, for example the reelable support member 1110 shown in FIG. 10, can include forming and compacting the plurality of composite strands 1112. The composite strands 1112 are formed and compacted to have an irregular, e.g. non-circular, cross-sectional shape using a die or a roller. This process can be combined with the melt fusing process described above. FIG. 20a shows a plurality of composite strands 1112 that have been wound around a core composite strand 1114. The composite strands are prepreg composite strands comprising carbon fibre and epoxy. Each composite strand 1112 comprises a support layer 1115 and a thermoplastic layer 1118. FIG. 20b shows the plurality of composite strands 1112 (including the core composite strand 1114) after forming and compacting the composite strands 1112, curing the epoxy of the composite strands 1112, and melting and fusing the thermoplastic layer 1118 of the composite strands 1112. The melted and fused thermoplastic layers 1118 fill the interstitial spaces 1116 between the composite strands 1112, e.g. between the support layers 1115 of the composite strands 1112, to prevent fluid migration along the reelable support member 1110. Beneficially, forming and compacting the composite strands 1112 reduces the size of the interstitial spaces 1116 between the composite strands 1112, as compared to a reelable support member that has not undergone the forming and compacting process.

The above detailed description is intended to be merely exemplary and non-limiting. It should be understood that features defined above in accordance with any aspect of the present disclosure or to any specific embodiment of the disclosure may be utilized, either alone or in combination with any other defined feature, in any other aspect or embodiment or to form a further aspect or embodiment of the disclosure.

What is claimed is:

1. A reelable support member for downhole operations, the member comprising a plurality of composite strands and a filler matrix between the plurality of composite strands, wherein each composite strand comprises carbon fibres and epoxy.

2. The reelable support member of claim 1, wherein the carbon fibres of each composite strand are unidirectional roving, twisted at an angle between 5° and 15°.

3. The reelable support member of claim 1, wherein the carbon fibres of each composite strand form between 55% and 70% of the volume of said composite strand.

4. The reelable support member of claim 1, wherein the carbon fibres of at least one composite strand of the plurality of composite strands are configured to transmit electrical signals for communication along the reelable support member, and optionally wherein a composite strand of the plurality of composite strands forms a core of the reelable support member, and wherein the carbon fibres of the composite strand forming the core are configured to transmit electrical signals for communication along the reelable support member.

5. (canceled)

6. The reelable support member of claim 1, wherein each composite strand comprises a protection wrap.

7. The reelable support member of claim 1, wherein the filler matrix is impermeable and fills interstitial spaces between the plurality of composite strands to prevent fluid migration along the reelable support member, and optionally wherein the interstitial spaces form less than 5% of the volume of the member.

8. (canceled)

9. The reelable support member of claim 1, wherein the reelable support member has a diameter between 3 mm and 30 mm.

10. The reelable support member of claim 1, wherein the reelable support member has a length up to 15000 m.

11. The reelable support member of claim 1, further comprising a support layer.

12. The reelable support member of claim 1, further comprising a polymer jacket, wherein the polymer jacket is the outer layer of the reelable support member.

13. A method of producing a reelable support member for downhole operations, the method comprising:
winding a plurality of composite strands around a core, each composite strand comprising carbon fibres and epoxy; and
applying a filler matrix between the plurality of composite strands.

14. The method of claim 13, wherein the plurality of composite strands are semi-cured before winding the plurality of composite strands around the core.

15. The method of claim 14, further comprising fully curing the plurality of composite strands after winding the plurality of composite strands around the core.

16. The method of claim 13, further comprising applying a protection wrap to each composite strand before winding the plurality of composite strands around the core.

17. The method of claim 13, wherein the filler matrix is applied to the plurality of composite strands during winding the plurality of composite strands around the core, and optionally wherein the method further comprises wiping excess filler from the plurality of composite strands after winding the plurality of composite strands around the core.

18. (canceled)

19. The method of claim 13, wherein the filler matrix is applied to the plurality of composite strands after winding the plurality of composite strands around the core; and optionally wherein the method further comprises opening the plurality of composite strands after winding the plurality of composite strands around the core, wherein applying the filler matrix between the plurality of composite strands comprises injecting the filler matrix between the opened plurality of composite strands; and optionally wherein the plurality of composite strands are semi-cured before winding the plurality of composite strands around the core, and the method further comprises fully curing the plurality of composite strands after winding the plurality of composite strands around the core, wherein the plurality of composite strands are opened after the plurality of composite strands are fully cured.

20-22. (canceled)

23. The method of claim 13, wherein the filler matrix is a flexible polymer, and optionally wherein the filler matrix is a thermoset polymer; and optionally wherein the method further comprises curing the filler matrix; and optionally wherein the plurality of composite strands are semi-cured before winding the plurality of composite strands around the core, and the method further comprises fully curing the plurality of composite strands after winding the plurality of composite strands around the core, wherein fully curing the plurality of composite strands and curing the filler matrix are done in a single curing operation.

24-25. (canceled)

26. The method of claim 13, wherein the filler matrix is a flexible polymer and optionally wherein the filler matrix is a thermoplastic polymer.

27. The method of claim 26, wherein applying the filler matrix between the plurality of composite strands comprises:
(i) jacketing the core with the filler matrix and heating the filler matrix of the jacketed core during winding the plurality of composite strands around the jacketed core such that the plurality of composite strands become embedded in the filler matrix of the jacketed core; or
(ii) wrapping the core with the filler matrix before winding the plurality of composite strands around the core, and after winding the plurality of composite strands around the core pulling the plurality of composite strands through a die to push the plurality of composite strands into the filler matrix material; or
(iii) applying a thermoplastic layer to each composite strand of the plurality of composite strands before winding the plurality of composite strands around the core, and heating the thermoplastic layers after winding the plurality of composite strands around the core.

28-29. (canceled)

30. The method of claim 13, further comprising jacketing the plurality of composite strands and the filler matrix with a polymer jacket compatible with the filler matrix and/or comprising the same material as the filler matrix to form an outer layer of the reelable support member, and, optionally, applying a support layer around the plurality of composite strands and the filler matrix before or at the same time as jacketing the plurality of composite strands and the filler matrix.

31. (canceled)

32. The reelable support member of claim 1, wherein the filler matrix is a flexible polymer.

33. The reelable support member of claim 32, wherein the filler matrix is a thermoset polymer or a thermoplastic polymer.
